(19) United States
(12) Patent Application Publication
(10) Pub. No.: US 2024/0147428 A1
(43) Pub. Date: May 2, 2024

(54) METHODS AND SYSTEMS FOR DETERMINING UPLINK COMMON FREQUENCY RESOURCE

(71) Applicant: ZTE Corporation, Shenzhen (CN)

(72) Inventors: Jing SHI, Shenzhen (CN); Xianghui HAN, Shenzhen (CN); Xingguang WEI, Shenzhen (CN); Shuaihua KOU, Shenzhen (CN); Xing LIU, Shenzhen (CN); Min REN, Shenzhen (CN)

(21) Appl. No.: 18/521,735

(22) Filed: Nov. 28, 2023

Related U.S. Application Data
(63) Continuation of application No. PCT/CN2022/073666, filed on Jan. 25, 2022.

(51) Int. Cl. H04W 72/02; H04L 5/14; H04W 72/0446; H04W 72/0453

(52) U.S. Cl. CPC H04W 72/02; H04L 5/1469; H04W 72/0446; H04W 72/0453

(57) ABSTRACT

Methods and systems for techniques for determining uplink common frequency resources are disclosed. In an implementation, a method of wireless communication includes determining, by a first device, one or multiple common resources for a transmission based on one or multiple sets of slots, and performing the transmission using the one or multiple common resources.

### CROSS-REFERENCE TO RELATED APPLICATION

This application is a continuation and claims priority to International Application No. PCT/CN2022/073666, filed on Jan. 25, 2022, the disclosure of which is hereby incorporated by reference herein in its entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for determining uplink common frequency resources.

In one aspect, a method of data communication is disclosed. The method includes determining, by a first device, one or multiple common resources for a transmission based on one or multiple sets of slots, and performing the transmission using the one or multiple common resources.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an uplink common frequency resource (UL CFR) that is configured based on a first pattern.

FIG. 4 shows two UL CFRs that are configured based on first and second patterns.

FIG. 5 shows a UL CFR in partial flexible (F) slots to avoid conflict with a synchronization signal (SS) physical broadcast channel (PBCH) block (SSB) and a first control resource set (CORESET0).

FIG. 6 shows a UL CFR in all F slots to resolve the conflict with SSB/CORESET0.

FIG. 7 shows an example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

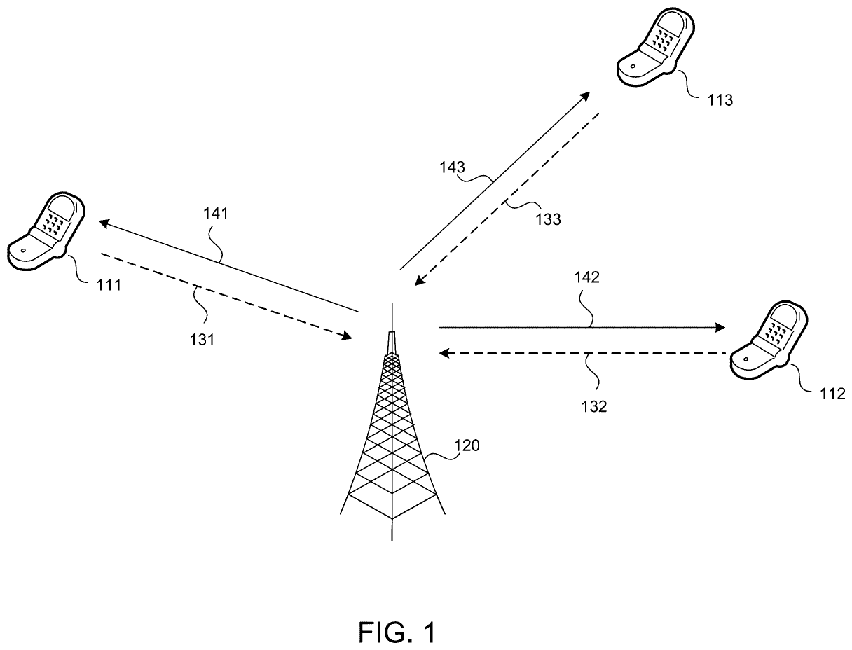

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

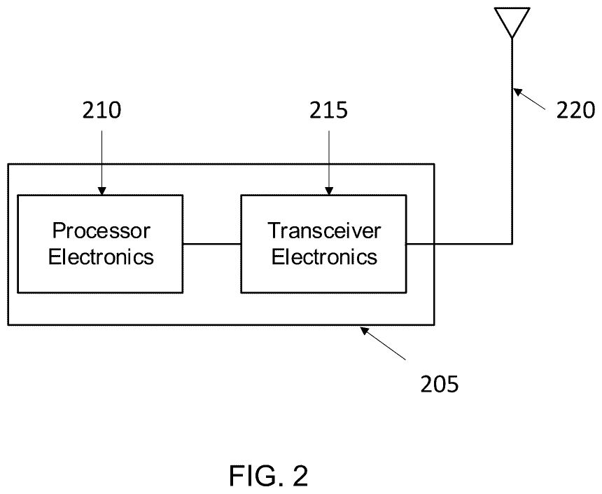

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

The 4th Generation mobile communication technology (4G) Long-Term Evolution (LTE) or LTE-Advance (LTE-A) and the 5th Generation mobile communication technology (5G) face more and more demands. Based on the current development trend, 4G and 5G systems support features of enhanced mobile broadband (eMBB), ultra-reliable low-latency communication (URLLC), and massive machine-type communication (mMTC). In addition, a full-duplex data transmission is a requirement for 5G and further communication system.

In the wireless communication system, the time domain resource is split between downlink and uplink in a time division duplex (TDD) system. Thus, the allocation of a limited time duration for the uplink in TDD would result in a reduced coverage and capacity and increased latency. As a possible enhancement on the conventional TDD operation, it would be worth studying the feasibility of allowing the simultaneous existence of downlink and uplink, such as a full duplex data transmission, or, more specifically, a subband non-overlapping full duplex at the gNB side within a conventional TDD band. The disclosed technology can be implemented in some embodiments to provide a frame structure for the subband non-overlapping full duplex.

In some embodiments of the disclosed technology, the determination of a resource or frame structure associated with the sub-band non-overlapped full duplex scheme includes determining an uplink common frequency resource (UL CFR) based on flexible slots and/or symbols. This has a low impact on the current or legacy UE related schemes and is flexible enough to apply the sub-band non-overlapped full duplex scheme to a TDD system.

In addition, the schemes using UL CFR would not impact the fundamental of the BWP mechanism. In some implementations, a common frequency resource from the view of gNB is determined for the sub-band non-overlapped full duplex, and such a common frequency resource can be referred as UL CFR or virtual bandwidth part (BWP). The UL CFRs with consecutive physical resource blocks (PRBs) are resources only for an uplink transmission, and the other resources except the UL CFR are resources for a downlink (DL) transmission. Optionally, there can be gaps between UL CFR and the resource for a DL transmission.

In some embodiments of the disclosed technology, the schemes that determine UL CFR based on flexible slots and/or symbols will not impact the TDD frame structure, especially for the semi-static D or U slots. Optionally, the semi-static D slots can also be configured with UL CFR if needed.

### Embodiment 1

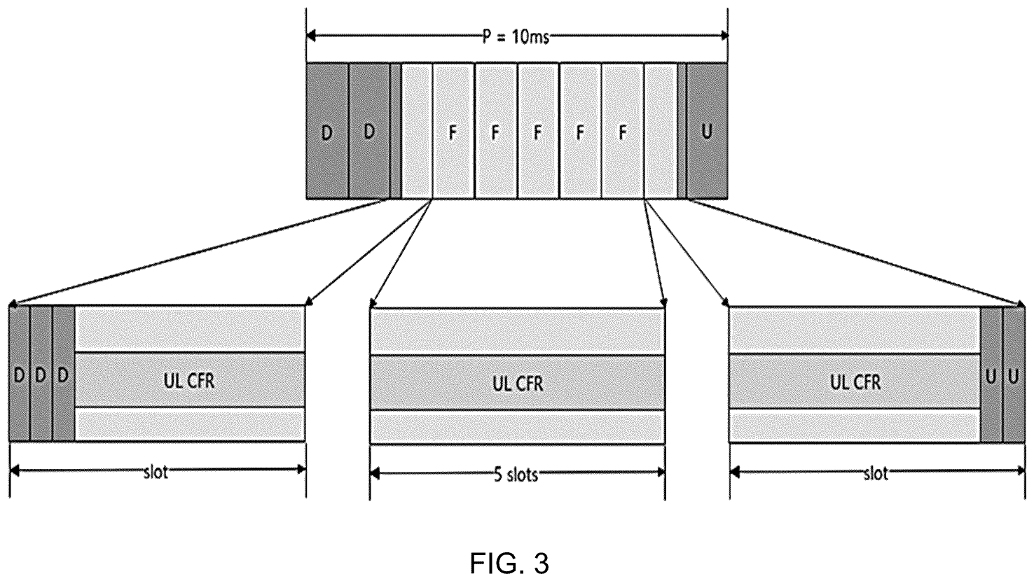

FIG. 3 shows an uplink common frequency resource (UL CFR) that is configured based on a first pattern.

In some embodiments of the disclosed technology, a UL CFR is determined by a semi-static configuration that is configured based on tdd-UL-DL-ConfigurationCommon. The UL CFR can be determined by a semi-static configuration that is configured for a UE or can be exchanged between gNBs. A set of slots, e.g., flexible slots and/or symbols in the semi-static configuration by a higher layer parameter tdd-UL-DL-ConfigurationCommon, are further configured with UL CFR.

In the current TDD semi-static frame structure, the frame structure is determined in a cell-specific manner based on a higher layer parameter tdd-UL-DL-ConfigurationCommon. In an embodiment, only a pattern 1 is configured, where the pattern 1 is only a single period is configured to determine the TDD frame structure.

In some implementations, the time domain for UL CFR application is determined in a cell-specific manner within a set of slots. Here, the set of slots are the slots with at least one F (flexible) symbol in each slot based on a semi-statically configured frame structure that is configured by a higher layer parameter tdd-UL-DL-ConfigurationCommon, or the set of slots are configured with a higher layer parameter. Optionally, the slots configured in the set of slots are all flexible slots, or the slots configured in the set of slots are D (downlink) slots and F slots. For example, in a case that a set of slots are slots that are not D or U slot, each slot includes at least one F symbol, as shown in FIG. 3, and the period of the pattern 1 in the tdd-UL-DL-ConfigurationCommon is 10 ms, and 2 D slots, 1 U slot, 3 D symbols, 2 U symbols are configured. The UL CFR can be configured within all the F slots and/or symbols.

In some implementations, the frequency domain resource of the UL CFR can be configured in the same manner as BWP or configured within each BWP. The starting PRB and the length of PRBs are configured to determine the frequency domain resource. Here, the same manner as BWP is that the starting PRB is referenced to Point A, i.e., the starting PRB is a PRB determined by subcarrierSpacing of the associated BWP and offsetToCarrier corresponding to this subcarrier spacing, similar to how locationAndBandwidth of a BWP is indicated as described in TS 38.331. Here, the starting PRB is referenced to the first PRB if configured within each BWP, and the first PRB can be based on a downlink BWP or an uplink BWP.

In an implementation, in a frequency domain, two sides (if present) of the UL CFR can be used as DL resources. In another implementation, DL CFR can be configured without consecutive PRBs, and the rest PRBs can be used as UL resources.

In some implementations, the frequency resources of the UL CFR in the set of slots are the same.

In this way, the sub-band non-overlapped full duplex can be achieved by determining the UL CFR based on a set of slots. The benefit of configuring UL CFR is that the fundamental of the BWP mechanism would not be impacted. In addition, a set of slots are optimized based on flexible slots and/or symbols such that the TDD frame structure will not be impacted especially for the semi-static D or U slots. Optionally, the semi-static D slots can also be configured with UL CFR if needed. The UL CFR based the sub-band non-overlapped full duplex is also beneficial for interactions between gNBs, because it is a cell-specific structure common to the UEs with the capability of sub-band non-overlapped full duplex.

### Embodiment 2

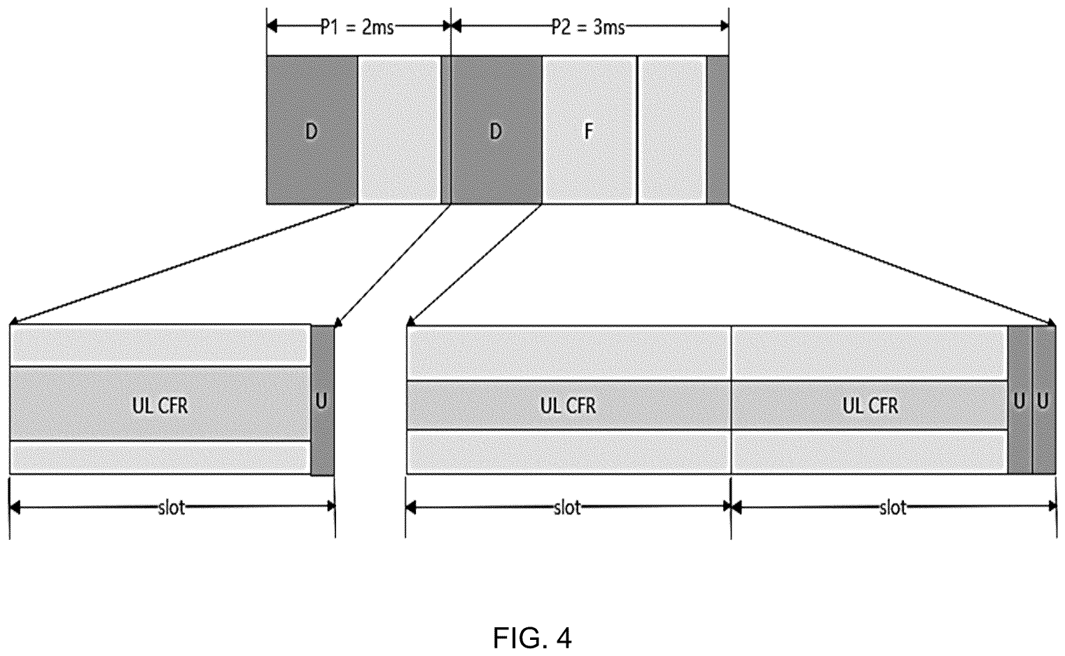

FIG. 4 shows two UL CFRs that are configured based on first and second patterns.

In some embodiments of the disclosed technology, multiple UL CFRs are determined by a semi-static configuration that is configured based on tdd-UL-DL-ConfigurationCommon. The UL CFR can be determined by a semi-static configuration that is configured for a UE or can be exchanged between gNBs. Multiple sets of slots are further configured with UL CFR.

In the current TDD semi-static frame structure, the frame structure is determined in a cell-specific manner based on a higher layer parameter tdd-UL-DL-ConfigurationCommon. In an embodiment, two patterns, pattern 1 and pattern 2, are configured. That is, two periods are configured to determine the TDD frame structure.

In some implementations, the time domain for UL CFR application is determined in a cell-specific manner within two sets of slots. Here, each set of slots includes slots whose pattern includes at least one F (flexible) symbol in each slot based on a semi-statically configured frame structure that is configured by a higher layer parameter tdd-UL-DL-ConfigurationCommon, or the set of slots are configured with one or more higher layer parameters. Optionally, the slots configured in the set of slots are all flexible slots, or the slots configured in the set of slots are D (downlink) slots and F slots.

In some implementations, the two UL CFR are configured for the two sets of slots. The frequency resource of the two UL CFR can be the same or can be configured independently, resulting in two different UL CFRs. For example, in a case that the first set of slots are the slots in pattern 1 which are not D or U slot, all slots with at least one F symbol are in pattern 1, and in a case that the second set of slots are the slots in pattern 2 which are not D or U slot, all slots with at least one F symbol are in pattern 2, as shown in FIG. 4, period of the pattern 1 in the tdd-UL-DL-ConfigurationCommon is 2 ms, and 1 D slot, 1 U symbol are configured; and the period of the pattern 2 in the tdd-UL-DL-ConfigurationCommon is 3 ms, and 1 D slot, 2 U symbols are configured. The semi-static frame structure is configured with pattern 1 and pattern 2, and UL CFR are combined with each pattern differently. Two UL CFRs are configured with a corresponding pattern of the semi-static frame structure configuration.

In some implementations, the frequency domain resource of the UL CFR in each set of slots can be configured in the same manner as BWP or configured within each BWP. The starting PRB and the length of PRBs are configured to determine the frequency domain resource. Here, the same manner as BWP manner is that the starting PRB is referenced to Point A, i.e., the starting PRB is a PRB determined by subcarrierSpacing of the associated BWP and offsetToCarrier corresponding to this subcarrier spacing, similar to how locationAndBandwidth of a BWP is indicated as described in TS 38.331. Here, the starting PRB is referenced to the first PRB if configured within each BWP, and the first PRB can be based on the downlink BWP or uplink BWP.

In an implementation, in a frequency domain, two sides (if present) of the UL CFR can be used as DL resources. In another implementation, DL CFR can be configured without consecutive PRBs, and the rest PRBs can be used as UL resources.

In some implementations, the frequency resources of the UL CFR in a set of slots are the same. The frequency resource of the UL CFR in different sets of slots can be the same as each other or different from each other.

In some implementations, multiple UL CFRs can be configured, and each UL CFR configuration is applied to each set of slots. That is, multiple sets of slots can be configured to apply the multiple UL CFR, where the frequency resources of the UL CFR in different sets of slots are configured independently.

In this way, the sub-band non-overlapped full duplex can be achieved by determining the UL CFR based on multiple sets of slots. The benefit of configuring UL CFR is that the fundamental of the BWP mechanism would not be impacted. In addition, a set of slots are optimized based on flexible slots and/or symbols such that the TDD frame structure will be not impacted especially for the semi-static D or U slots. Optionally, the semi-static D slots can also be configured with UL CFR if needed. The UL CFR based sub-band non-overlapped full duplex is also beneficial for interactions between gNBs, because it is a cell-specific structure common to the UEs with the capability of sub-band non-overlapped full duplex.

### Embodiment 3

In some embodiments of the disclosed technology, one or more UL CFRs are determined by a semi-static configuration that is configured based on tdd-UL-DL-ConfigurationCommon and tdd-UL-DL-ConfigurationDedicated.

In some implementations, UL CFR can be determined by a semi-static configuration that is configured for a UE or can be exchanged between gNBs. A set of slots, e.g., flexible slots and/or symbols in the semi-static configuration by a higher layer parameter tdd-UL-DL-ConfigurationCommon and tdd-UL-DL-ConfigurationDedicated, are further configured with UL CFR. Optionally, multiple sets of slots are further configured with UL CFR.

In the current TDD semi-static frame structure, the frame structure is at least determined by a higher layer parameter tdd-UL-DL-ConfigurationCommon and optionally further based on a higher layer parameter tdd-UL-DL-ConfigurationDedicated. Combined with other embodiments, one or two patterns are configured (e.g., only pattern 1, or both pattern 1 and pattern 2). The time domain for UL CFR application is determined in a UE-specific manner within one or two sets of slots. Here, the set of slots are the slots with at least one F (flexible) symbol in each slot based on a semi-static configuration that is configured frame structure by a higher layer parameter tdd-UL-DL-ConfigurationCommon and tdd-UL-DL-ConfigurationDedicated, or the set of slots are configured with a higher layer parameter. Optionally, the slots configured in the set of slots are all flexible slots, or the slots configured in the set of slots are D (downlink) slots and F slots. The frequency domain resource of the UL CFR in each set of slots can be configured in the same manner as BWP or configured within each BWP. The starting PRB and the length of PRBs are configured to determine the frequency domain resource. Here, the same manner as BWP is that the starting PRB is referenced to Point A, i.e., the starting PRB is a PRB determined by subcarrierSpacing of the associated BWP and offsetToCarrier corresponding to this subcarrier spacing, similar to how locationAndBandwidth of a BWP is indicated as described in TS 38.331. Here, the starting PRB is referenced to the first PRB if configured within each BWP, the first PRB can be based on the downlink BWP or uplink BWP.

In an implementation, in a frequency domain, two sides (if present) of the UL CFR can be used as DL resources. In another implementation, DL CFR can be configured without consecutive PRBs, and the rest PRBs can be used as UL resources.

In some implementations, the frequency resources of the UL CFR in a set of slots are the same. Optionally, the frequency resources of the UL CFR in different sets of slots can be the same as each other or different from each other.

In some implementations, multiple UL CFRs can be configured, and each UL CFR configuration applied with each set of slots. That is, multiple sets of slots can be configured to apply the multiple UL CFR, where the frequency resources of the UL CFR in different sets of slots are configured independently.

This may derive different sub-band non-overlapped full duplex structures for different UEs. That is, a UE-specific manner determines the UL CFR within a set of slots. When sub-band non-overlapped full duplex structures need to be exchanged between gNBs, then the gNB will interact with each other to share sub-band non-overlapped full duplex structures common to different UEs in a serving cell.

In this way, the sub-band non-overlapped full duplex can be achieved by determining the UL CFR based on one or more sets of slots. The benefit of configuring UL CFR is that the fundamental of the BWP mechanism would not be impacted. In addition, a set of slots are optimized based on flexible slots and/or symbols that the TDD frame structure will be not impacted especially for the semi-static D or U slots. Optionally, the semi-static D slots can also be configured with UL CFR if needed. The UL CFR based sub-band non-overlapped full duplex is also beneficial for interactions between gNBs, because it is a union structure common to the UEs with the capability of sub-band non-overlapped full duplex.

### Embodiment 4

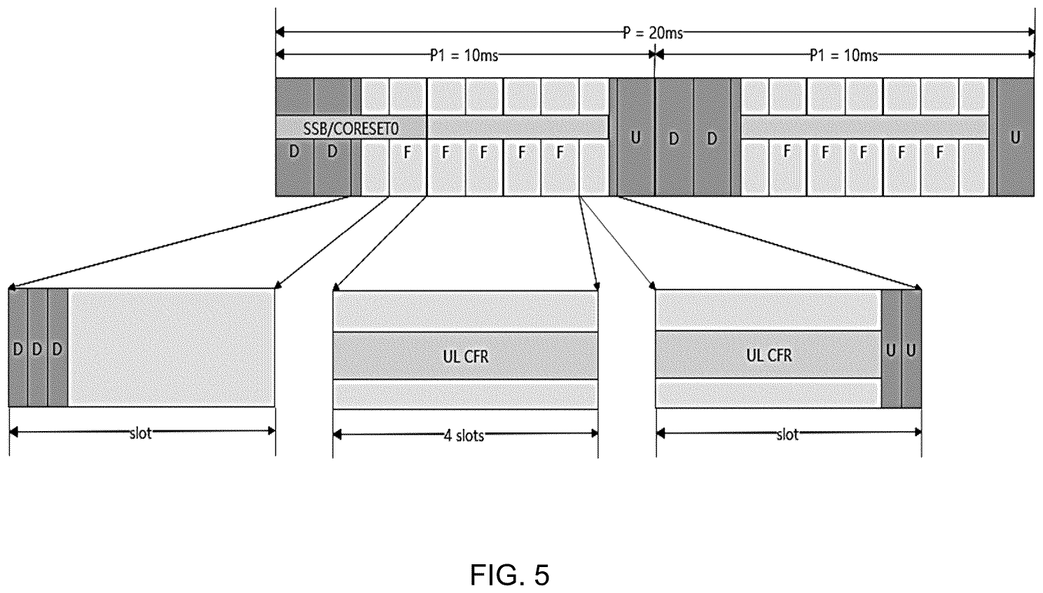

FIG. 5 shows a UL CFR in partial flexible (F) slots to avoid conflict with a synchronization signal (SS) physical broadcast channel (PBCH) block (SSB) and a first control resource set (CORESET0).

In some embodiments of the disclosed technology, UL CFR applied in a set of slots includes partial F slots that are not in conflict with the SSB/CORESET0. One or more UL CFRs are determined by a semi-static configuration that is configured based on tdd-UL-DL-ConfigurationCommon (or optionally combined with tdd-UL-DL-ConfigurationDedicated).

In some implementations, UL CFR can be determined by a semi-static configuration that is configured for a UE or can be exchanged between gNBs. A set of slots, e.g., partial flexible slots and/or symbols in the semi-static configuration are determined at least by a higher layer parameter tdd-UL-DL-ConfigurationCommon and are not in conflict with at least one of SSB and CORESET0, and are further configured with UL CFR. Here, SSB is configured by ssb-PositionsInBurst in SIB1 or ServingCellConfigCommon, and CORESET0 is configured by pdcch-ConfigSIB1 in MIB. Optionally, multiple sets of slots are further configured with UL CFR.

In the current TDD semi-static frame structure, the frame structure is at least based on a higher layer parameter tdd-UL-DL-ConfigurationCommon. Combined with other embodiments, the time domain for UL CFR application is determined within one or more sets of slots. Here, the set of slots are the slots with at least one F (flexible) symbol in each slot based on a semi-static configuration that is configured frame structure at least by a higher layer parameter tdd-UL-DL-ConfigurationCommon and not in conflict with at least one of SSB and CORESET0, or the set of slots are configured with a higher layer parameter. Optionally, the slots configured in the set of slots are all flexible slots, or the slots configured in the set of slots are D (downlink) slots and F slots. In some implementations, the priority of the semi-static D/U and SSB/CORESET0 in the frame structure is higher than the UL CFR configuration. A set of slots includes partial F slots that would not impact the SSB/CORESET0. For example, as shown in FIG. 5, the period of the pattern 1 in the tdd-UL-DL-ConfigurationCommon is 10 ms, and 2 D slots, 1 U slot, 3 D symbols, 2 U symbols are configured, and no pattern 2 is configured, and a set of slots in two radio frames are slots #4, 5, 6, 7, 8 in the first radio frame and slot #2, 3, 4, 5, 6, 7, 8 in the second radio frame, where ten slots in a radio frame are numbered #0-9 and the SCS in the figure is 15 khz. The partial F slots without SSB/CORESET0 are configured with UL CFR.

In some implementations, the frequency domain resource of the UL CFR in each set of slots can be configured in the same manner as BWP or configured within each BWP. The starting PRB and the length of PRBs are configured to determine the frequency domain resource. Here, the same manner as BWP is that the starting PRB is referenced to Point A, i.e., the starting PRB is a PRB determined by subcarrierSpacing of the associated BWP and offsetToCarrier corresponding to this subcarrier spacing, similar to how locationAndBandwidth of a BWP is indicated as described in TS 38.331. Here, the starting PRB is referenced to the first PRB if configured within each BWP, and the first PRB can be based on the downlink BWP or uplink BWP.

In an implementation, in frequency domain, two sides (if present) of the UL CFR can be used as DL resources. In another implementation, DL CFR can be configured without consecutive PRBs, and the rest PRBs can be used as UL resources.

The frequency resources of the UL CFR in a set of slots are the same. Optionally, the frequency resources of the UL CFR in different sets of slots can be the same as each other or different from each other.

In some implementations, multiple UL CFRs can be configured, and each UL CFR configuration is applied to each set of slots. That is, multiple sets of slots can be configured to apply the multiple UL CFR, where the frequency resource of the UL CFR in different sets of slots are configured independently.

In this way, the sub-band non-overlapped full duplex can be achieved by determining the UL CFR based on one or more sets of slots which are not in conflict with SSB/CORESET0. The benefit of configuring UL CFR is that the fundamental of the BWP mechanism would not be impacted. In addition, a set of slots are optimized based on flexible slots and/or symbols such that the TDD frame structure will be not impacted especially for the semi-static D or U slots. Optionally, the semi-static D slots can also be configured with UL CFR if needed. The UL CFR based sub-band non-overlapped full duplex is also beneficial for interactions between gNBs, because it is a cell-specific or union structure common to the UEs with the capability of sub-band non-overlapped full duplex.

### Embodiment 5

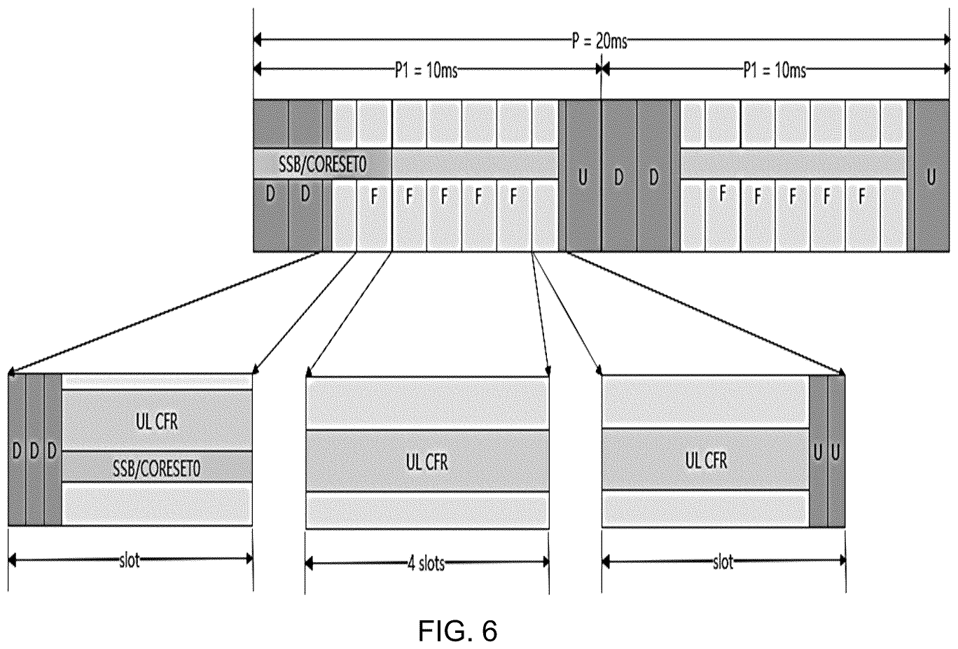

FIG. 6 shows a UL CFR in all F slots to resolve the conflict with SSB/CORESET0.

The disclosed technology can be implemented in some embodiments to provide UL CFR applied in all/partial F slots and a rule to avoid conflict the SSB/CORESET0. One or more UL CFRs are determined by a semi-static configuration that is configured based on tdd-UL-DL-ConfigurationCommon (or optionally combined with tdd-UL-DL-ConfigurationDedicated).

In some implementations, UL CFR can be determined by a semi-static configuration that is configured for a UE or can be exchanged between gNBs. A set of slots, e.g., all/partial flexible slots and/or symbols in the semi-static configuration at least by a higher layer parameter tdd-UL-DL-ConfigurationCommon are further configured with UL CFR and a rule to resolve the conflict with at least one of SSB and CORESET0. Here, SSB is configured by ssb-PositionsInBurst in SIB1 or ServingCellConfigCommon, and CORESET0 is configured by pdcch-ConfigSIB1 in MIB. Optionally, multiple sets of slots are further configured with UL CFR. In the current TDD semi-static frame structure, the frame structure is at least based on a higher layer parameter tdd-UL-DL-ConfigurationCommon. Combined with other embodiments, the time domain for UL CFR application is determined within one or more sets of slots.

Here, the set of slots are the slots with at least one F (flexible) symbol in each slot based on a semi-static configuration that is configured frame structure at least by a higher layer parameter tdd-UL-DL-ConfigurationCommon, or the set of slots are configured with a higher layer parameter. Optionally, the slots configured in the set of slots are all flexible slots, or the slots configured in the set of slots are D (downlink) slots and F slots.

In some implementations, the priority of the semi-static D/U and SSB/CORESET0 in the frame structure is higher than the UL CFR configuration. A set of slots includes all/partial F slots. UL CFR is applied in all/partial F slots and the disclosed technology can be implemented in some embodiments to avoid impacting the SSB/CORESET0, as discussed below.

Alternative 1: UL CFRs are determined with an offset based on the highest PRB index of the SSB/CORESET0.

Alternative 2: UL CFRs are determined with an offset based on the lowest PRB index of the SSB/CORESET0.

Alternative 3: UL CFRs are divided by the SSB/CORESET0, that is SSB/CORESET0 are contained within the UL CFR. The PRB size of the UL CFR is unchanged.

Alternative 4: UL CFR is punctured by the SSB/CORESET0.

Take Alternative 1 as an example, as shown in FIG. 6, the period of the pattern 1 in the tdd-UL-DL-ConfigurationCommon is 10 ms, and 2 D slots, 1 U slot, 3 D symbols, 2 U symbols are configured, and no pattern 2 configured, and a set of slots in two radio frames includes slot #2, 3, 4, 5, 6, 7, 8 in the both radio frames, where ten slots in a radio frame are numbered #0-9 and the SCS in the figure is 15 khz. In a case that UL CFR and SSB/CORESET0 are in conflict in slots #2 and 3 in the first radio frame, UL CFR is determined based on the start PRB plus an additional offset. That is, UL CFRs are determined with an offset based on the highest PRB index of the SSB/CORESET0.

In some implementations, the frequency domain resource of the UL CFR in each set of slots can be configured in the same manner as BWP or configured within each BWP. The starting PRB and the length of PRBs are configured to determine the frequency domain resource. Here, the same manner as BWP is that the starting PRB is referenced to Point A, i.e., the starting PRB is a PRB determined by subcarrierSpacing of the associated BWP and offsetToCarrier corresponding to this subcarrier spacing, similar to how locationAndBandwidth of a BWP is indicated as described in TS 38.331. Here, the starting PRB is referenced to the first PRB if configured within each BWP, and the first PRB can be based on the downlink BWP or uplink BWP.

In an implementation, in the frequency domain, two sides (if present) of the UL CFR can be used as DL resources. In another implementation, DL CFR can be configured without consecutive PRBs, and the rest PRBs can be used as UL resources.

The frequency resource of the UL CFR in a set of slots are the same. Optionally, the frequency resource of the UL CFR in different sets of slots can be the same as each other or different from each other.

In some implementations, multiple UL CFRs can be configured, and each UL CFR configuration is applied to each set of slots. That is, multiple sets of slots can be configured to apply the multiple UL CFR, where the frequency resource of the UL CFR in different sets of slots are configured independently.

In this way, the sub-band non-overlapped full duplex can be achieved by determining the UL CFR based on one or more sets of slots and the conflict with SSB/CORESET0 is resolved in this embodiment. The benefit of configuring UL CFR is that the fundamental of the BWP mechanism would not be impacted. In addition, a set of slots are optimized based on flexible slots and/or symbols that the TDD frame structure will be not impacted especially for the semi-static D or U slots. Optionally, the semi-static D slots can also be configured with UL CFR if needed. The UL CFR based sub-band non-overlapped full duplex is also beneficial for interactions between gNBs, because it is a cell-specific or union structure common to the UEs with the capability of sub-band non-overlapped full duplex.

### Embodiment 6

In some implementations, UL CFR is determined based on a dynamic indication.

Under the current standard, the dynamic indication SFI (slot format indicator) carried by DCI format 2_0 cannot override the semi-static configuration D/U at least by a higher layer parameter tdd-UL-DL-ConfigurationCommon. Similar to SFI, a dynamic UL CFR can be indicated by an independent DCI format or combined with DCI format 2_0. The indication PRBs number can reuse the legacy type 0/1 resource allocation to derive consecutive PRBs.

In some implementations, UL CFR is determined based on a dynamic indication. In some implementations, the UL CFR with the frame structure indicated by SFI is determined by one of the following alternatives.

Alternative 1: The UL CFR is only applied to F slots and/or symbols indicated by SFI. That is, D symbols indicated by SFI cannot be overridden by UL CFR. If SFI is configured but not received by UE, the UL CFR is applied to the F slots and/or symbols configured by a semi-static configuration at least by a higher layer parameter tdd-UL-DL-ConfigurationCommon.

Alternative 2: The UL CFR is applied to all slots and/or symbols indicated by SFI. That is, D symbols indicated by SFI can be overridden by UL CFR.

Similar to other embodiments, a set of slots for applying the UL CFR can be implicitly derived from the semi-static frame structure configuration, where the slots in the set of slots include at least one F symbol. Alternatively, the set of slots can be configured with a higher layer parameter. Optionally, the slots configured in the set of slots are all flexible slots, or the slots configured in the set of slots are D (downlink) slots and F slots.

In addition, the frequency resource of the UL CFR can be dynamically indicated as discussed above by an independent DCI format or combined with DCI format 2_0. Similar to other embodiments, the frequency domain resource of the UL CFR in each set of slots can be configured in the same manner as BWP or configured within each BWP by configuration. In an implementation, in the frequency domain, two sides (if present) of the UL CFR can be used as DL resources. In another implementation, DL CFR can be configured without consecutive PRBs, and the rest PRBs can be used as UL resources. The frequency resource of the UL CFR in a set of slots are the same. Optionally, the frequency resource of the UL CFR in different sets of slots can be the same as each other or different from each other. In some implementations, multiple UL CFR can be configured, and each UL CFR configuration is applied to each set of slots. That is, multiple sets of slots can be configured to apply the multiple UL CFR, where the frequency resources of the UL CFR in different sets of slots are configured independently.

In this way, the sub-band non-overlapped full duplex can be achieved by determining the UL CFR based on one or more sets of slots by a more flexible dynamic manner. The benefit of indicating UL CFR is that the fundamental of the BWP mechanism would not be impacted. In addition, a set of slots are optimized based on flexible slots and/or symbols that the TDD frame structure will be not impacted especially for the semi-static D or U slots. Optionally the semi-static D slots can also be configured with UL CFR if needed. The UL CFR based sub-band non-overlapped full duplex is also beneficial for interactions between gNBs, because it is a structure common to the UEs with the capability of sub-band non-overlapped full duplex.

In some embodiments of the disclosed technology, the resource determination of the sub-band non-overlapped full duplex includes determining the UL CFR based on the flexible slots and/or symbols.

The disclosed technology can be implemented in some embodiments to provide a Cell/UE-specific manner to determine the UL CFR within a set of slots. Here, a set of slots includes all/partial F slots and/or symbols based on a semi-static configuration that is configured frame structure at least by a higher layer parameter tdd-UL-DL-ConfigurationCommon, or a set of slots are configured by a higher layer parameter.

In some implementations, two UL CFR are configured with the corresponding Pattern 1 and Pattern 2 of the semi-static frame structure configuration. Further, multiple UL CFRs can be configured, and each UL CFR configuration applied to each set of slots.

In some implementations, UL CFR applied in a set of slots includes partial F slots that are not in conflict with the SSB/CORESET0.

In some implementations, UL CFR is applied in all/partial F slots while avoiding a conflict with the SSB/CORESET0 based on one of the following alternatives.

Alternative 1: UL CFRs are determined with an offset based on the highest PRB index of the SSB/CORESET0.

Alternative 2: UL CFRs are determined with an offset based on the lowest PRB index of the SSB/CORESET0.

Alternative 3: UL CFRs are divided by the SSB/CORESET0. That is, SSB/CORESET0 are contained within the UL CFR. The PRB size of the UL CFR is unchanged.

Alternative 4: UL CFR is punctured by the SSB/CORESET0.

In some implementations, UL CFR is determined based on a dynamic indication.

In one example, when UL CFR is determined based on a dynamic indication, the UL CFR can be applied to the frame structure based on one of the following alternatives.

Alternative 1: The UL CFR is only applied to F slots and/or symbols indicated by SFI. That is, D indicated by SFI cannot be overridden by UL CFR.

Alternative 2: The UL CFR is applied with all slots and/or symbols indicated by SFI. That is, D indicated by SFI can be overridden by UL CFR.

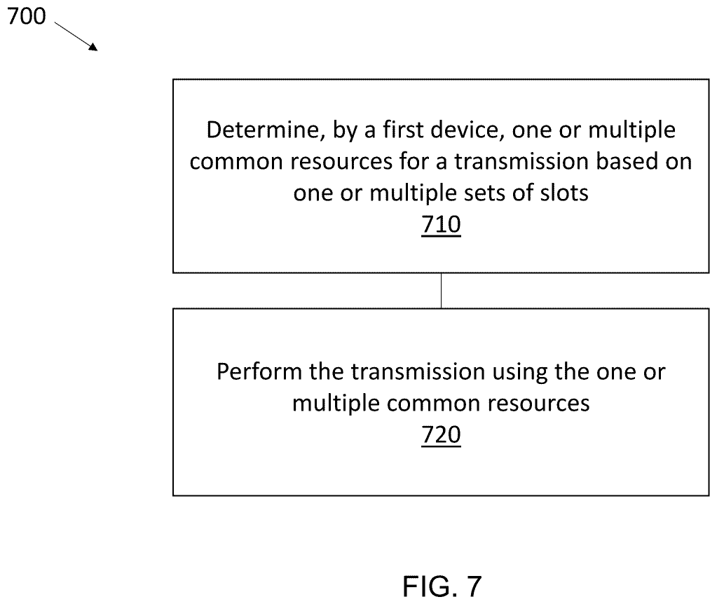

FIG. 7 shows an example of a process for wireless communication based on some example embodiments of the disclosed technology.

In some implementations, the process 700 for wireless communication may include, at 710, determining, by a first device, one or multiple common resources for a transmission based on one or multiple sets of slots; and at 720 performing the transmission using the one or multiple common resources.

Here, the first device can be UE or gNB.

In some implementations, the transmission can be performed using a full duplex scheme comprising use of a same time resource and different frequency resources for an DL transmission and an UL transmission. In some implementations, the one or multiple common resources determined by a first device can be indicated to another device. The other device can be the same type or a different type than the first device. That is, gNB determines the UL CFR, which can be indicated to another gNB or a UE. In some implementations, the first device can be a user device such as UE or a network device at the base station.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: determining, by a first device, one or multiple common resources for a transmission based on one or multiple sets of slots; and performing the transmission using the one or multiple common resources.

Here, the first device can be UE or gNB.

In some implementations, the transmission can be performed using a full duplex scheme comprising use of a same time resource and different frequency resources for an DL transmission and an UL transmission. In some implementations, the one or multiple common resources determined by a first device can be indicated to another device. The other device can be the same type or a different type than the first device. That is, gNB determines the UL CFR, which can be indicated to another gNB or a UE. In some implementations, the first device can be a user device such as UE or a network device at the base station.

Clause 2. The method of clause 1, wherein the one or multiple common resources include an uplink common frequency resource (UL CFR) that uses at least one of downlink resource and flexible resource for an uplink transmission.

In some implementations, the one or multiple common resources include a downlink common frequency resource (DL CFR) that uses at least one of an uplink resource and a flexible resource for a downlink transmission

Clause 3. The method of clause 1, wherein the slots in the one or multiple sets of slots include only one or multiple flexible slots or symbols.

Clause 4. The method of clause 1, wherein the slots in the one or multiple sets of slots include one or multiple downlink or flexible slots or symbols.

Clause 5. The method of clause 1, wherein the one or multiple sets of slots are configured by a higher layer parameter or are implicitly derived from a parameter configured for frame structure.

Clause 6. The method of any of clauses 1-5, wherein the one or multiple common resources are determined based on one or more configurations for frame structure.

Clause 7. The method of clause 6, wherein the one or more configurations for frame structure include a time division duplex (tdd)-uplink (UL)-downlink (DL)-configuration common parameter.

Clause 8. The method of any of clauses 6-7, wherein the one set of slots includes all or partially flexible slots or symbols based on at least one of a first pattern and a second pattern configured by the one configuration for frame structure.

In some implementations, the first pattern or the second pattern can be configured with at least one of the numbers of uplink slots and symbols, downlink slots and symbols, or none of them. The rest of slots or symbols are flexible slots or symbols in a case at least one of the numbers of uplink slots and symbols, downlink slots and symbols are configured. In a case none of them are configured, all slots and symbols are flexible.

Clause 9. The method of any of clauses 6-7, wherein the multiple set of slots are two sets of slots that include all or partially flexible slots or symbols based on a first pattern and a second pattern, respectively, configured by the one configuration for frame structure.

Clause 10. The method of any of clauses 8-9, wherein the UL CFR is configured within each set of slots independently or a same UL CFR is configured within all sets of the slots.

Clause 11. The method of clause 6, wherein the one or more configurations for frame structure include at least one of a common configuration parameter common to all user devices and a user device specific configuration parameter.

Clause 12. The method of any of clauses 6-11, wherein the one or multiple sets of slots for UL CFR configuration does not include slots that includes at least one of a synchronization signal (SS) physical broadcast channel (PBCH) block (SSB) and a control resource set (CORESET).

Clause 13. The method of any of clauses 6-11, wherein the UL CFR is shifted in a slot or symbol that includes at least one of an SSB and a CORESET by an offset based on a highest or lowest physical resource block index of the SSB or the CORESET.

Clause 14. The method of any of clauses 6-11, wherein the UL CFR is divided in a slot or symbol that includes at least one of an SSB and a CORESET by the SSB or the CORESET with a same physical resource block (PRB) number as a PRB number of the UL CFR in the slot without at least one of an SSB and a CORESET.

Clause 15. The method of any of clauses 6-11, wherein the UL CFR is punctured in a slot or symbol that includes at least one of an SSB and a CORESET by at least one of the SSB and the CORESET.

Clause 16. The method of clause 1, wherein the one or multiple common resources are determined based on at least one of a higher layer configuration and a dynamic indication for frame structure.

Clause 17. The method of clause 16, wherein the one or multiple common resources includes an uplink common frequency resource (UL CFR) applied only to a flexible symbol indicated by the dynamic indication for frame structure.

Clause 18. The method of clause 16, wherein the one or multiple common resources includes a UL CFR applied to at least one of a downlink symbol and a flexible symbol indicated by the dynamic indication for frame structure.

Clause 19. An apparatus for wireless communication comprising a processor that is configured to carry out the method of any of clauses 1 to 18.

Clause 20. A non-transitory computer readable medium having code stored thereon, the code when executed by a processor, causing the processor to implement a method recited in any of clauses 1 to 18.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
determining, by a first device, one or multiple common resources for a transmission based on one or multiple sets of slots; and
performing the transmission using the one or multiple common resources.

2. The method of claim 1, wherein the one or multiple common resources include an uplink common frequency resource (UL CFR) that uses at least one of downlink resource and flexible resource for an uplink transmission.

3. (canceled)

4. The method of claim 1, wherein the slots in the one or multiple sets of slots include one or multiple downlink or flexible slots or symbols.

5. The method of claim 1, wherein the one or multiple sets of slots are configured by a higher layer parameter or are implicitly derived from a parameter configured for frame structure.

6. The method of claim 1, wherein the one or multiple common resources are determined based on one or more configurations for frame structure.

7. The method of claim 6, wherein the one or more configurations for frame structure include a time division duplex (tdd)-uplink (UL)-downlink (DL)-configuration common parameter.

8. The method of claim 6, wherein the one set of slots includes at least partially downlink or flexible slots or symbols based on at least one of a first pattern and a second pattern configured by the one configuration for frame structure.

9. The method of claim 6, wherein the multiple set of slots are two sets of slots that include at least partially downlink or flexible slots or symbols based on a first pattern and a second pattern, respectively, configured by the one configuration for frame structure.

10. The method of claim 9, wherein a UL CFR is configured within each set of slots independently or a same UL CFR is configured within all sets of the slots.

11. The method of claim 6, wherein the one or more configurations for frame structure include at least one of a common configuration parameter common to all user devices and a user device specific configuration parameter.

12. The method of claim 6, wherein the one or multiple sets of slots for UL CFR configuration does not include slots or symbols that include at least one of a synchronization signal (SS) physical broadcast channel (PBCH) block (SSB) and a control resource set (CORESET).

13. The method of claim 6, wherein a UL CFR is shifted in a slot or symbol that includes at least one of an SSB and a CORESET by an offset based on a highest or lowest physical resource block index of the SSB or the CORESET.

14. The method of claim 6, wherein a UL CFR is divided in a slot or symbol that includes at least one of an SSB and a CORESET by the SSB or the CORESET with a same physical resource block (PRB) number as a PRB number of the UL CFR in the slot without at least one of an SSB and a CORESET.

15. The method of claim 6, wherein a UL CFR is punctured in a slot or symbol that includes at least one of an SSB and a CORESET by at least one of the SSB and the CORESET.

16. The method of claim 1, wherein the one or multiple common resources are determined based on at least one of a higher layer configuration and a dynamic indication for frame structure.

17. The method of claim 16, wherein the one or multiple common resources includes an uplink common frequency resource (UL CFR) applied only to a flexible symbol indicated by the dynamic indication for frame structure.

18. The method of claim 16, wherein the one or multiple common resources includes a UL CFR applied to at least one of a downlink symbol and a flexible symbol indicated by the dynamic indication for frame structure.

19. An apparatus for wireless communication comprising a processor that is configured to carry out a method, comprising:
determining one or multiple common resources for a transmission based on one or multiple sets of slots; and
performing the transmission using the one or multiple common resources.

20. (canceled)

21. The apparatus of claim 19, wherein the one or multiple common resources include an uplink common frequency resource (UL CFR) that uses at least one of downlink resource and flexible resource for an uplink transmission.

22. The apparatus of claim 19, wherein the slots in the one or multiple sets of slots include one or multiple downlink or flexible slots or symbols.
